(19) United States
(12) Patent Application Publication
(10) Pub. No.: US 2025/0196380 A1
(43) Pub. Date: Jun. 19, 2025

(54) SCISSORS

(71) Applicant: INSOLENT, Lyon (FR)

(72) Inventor: Wilfrid KOUZNETZOFF, Lyon (FR)

(21) Appl. No.: 18/844,894

(22) PCT Filed: Mar. 8, 2023
(86) PCT No.: PCT/IB2023/052195

§ 371 Date: Sep. 6, 2024

(30) Foreign Application Priority Data
Mar. 9, 2022 (FR) FR2202073

(51) Int. Cl. B26B 13/20

(52) U.S. Cl. CPC B26B 13/20

(57) ABSTRACT

Scissors, comprising first and second mounted blades that rotate in relation to each other around a rotation axis, an eyelet attached to the first blade, the axis being positioned between the eyelet and the first blade.

The present invention relates to the technical field of articulated objects. More specifically, it relates to the technical field of scissors, and in particular scissors intended for cutting hair.

For the purposes of this description, an interval described by the phrase “between [ . . . ] and [ . . . ]” includes the terminals. For example, the interval “between 1 and 2” includes the two values “1” and “2” as well as the set of values that are both strictly greater than 1 and strictly less than 2.

For the purposes of this description, the term “about” preceding a numerical value means that the value can be changed by plus or minus 10%. In the special case of a numeric value being an interval bound, the term “about” means that the low bound can be reduced by 10% or the high bound can be increased by 10%. It is also possible to remove the term “about” preceding a numeric value.

Scissors, and especially those known for hairdressing, typically feature two mounted blades that rotate relative to each other around an axis.

Each blade has a respective eyelet with which it is attached. The axis is positioned between a blade and its eyelet. Each eyelet allows a user to position one or more fingers in order to use their respective blade by pivoting around the axis.

In practice, most often, one eyelet is reserved for the user's thumb, and the other is reserved for one or more finger(s) other than the thumb.

For the purposes of this description, a “user” is a scissor user. This can include a hairdresser.

The practice of hairdressing requires a large number of movements and changes in the position of the scissors.

Users most often perform these movements by rotating and moving the wrist.

Such movements and rotations of the wrist are the cause of many musculoskeletal disorders (hereinafter “MSDs”) such as tendonitis, which can be particularly disabling for the professional practice of hairdressing. These conditions are very common among hairdressers, who are sometimes forced to stop their professional activity because of these conditions.

In the context of cutting an individual's hair, the position of the scissors, and in particular the cutting plane, must be substantially constant in relation to the surface of the scalp, regardless of where the cut is made, on and around the individual's head.

The grip of the scissors is most often achieved by engaging the thumb in one eyelet of the scissors, and at least one finger in the other eyelet of the scissors.

The cutting movement is mainly carried out by the thumb, while the other fingers remain relatively immobile.

When the thumb is fully engaged in the eyelet, it cannot be used for anything other than to operate the scissors.

In particular, it will not be able to act on the position of the cutting plane in relation to the scalp, or in a very marginal way.

Thus, when using scissors, many extreme and potentially traumatic movements will have to be performed by other joints, and in particular that of the wrist.

It is in this context that scissor users are particularly exposed to a large number of health risks, including:
the aforementioned MSDs, related to the user's postures and gestures, which are uncomfortable and often repeated; they are extremely frequent and lead to disabling osteoarticular pathologies;
cuts, which can in some cases lead to direct contamination, particularly with regard to blood-borne diseases.

As mentioned earlier, depending on the position of the head and the place where the hair is to be cut, adapting the position of the scissors is sometimes difficult, and in particular requires a variable rotation of the wrist including extreme positions, which is problematic for the health of the user.

When the user suffers from particular pathologies, in particular osteoarthritis, these problems are further amplified.

In the prior art, a number of approaches were proposed to improve the ergonomics of hairdressing scissors.

First of all, it was attempted to make scissors with branches curved at right angles.

For example, the WO2002094512 application (KIM) discloses scissors with branches at right angles or substantially at right angles.

In the U.S. Pat. No. 5,232,000 application (CHIAVARAS), scissors with right-angled branches are also described as being more ergonomic.

In practice, these scissors do not limit the risks, and are not very ergonomic. In addition, their wear, and in particular the wear of the hinge, is premature due to the position of the eyelets.

Then, it was attempted to make scissors with one or more hinges supposed to improve ergonomics.

Thus, in the application U.S. Pat. No. 5,469,624 (BRENTON), it is disclosed scissors comprising a thumb eyelet mounted on a hinge perpendicular to the thumb temple, this eyelet can be disassembled and its size adapted to the user. In the application US20050204569 (BRENTON), it is disclosed scissors comprising an incomplete thumb eyelet mounted on a hinge perpendicular to the thumb temple, this incomplete eyelet can be disassembled and its size adapted to the user.

Other requests with similar disclosures include US20080172886 (DONG HO JUN), US20100212165 (PARNAZZINI ET AL.) and WO2007133567 (FOX).

In the application US20050005456 (WANG ET AL.), scissors comprising a thumb eyelet mounted on a hinge arranged in the extension of the thumb branch are disclosed.

Finally, in the application WO2014132279 (DE STEFANO), scissors comprising two rotating eyelets, presented as allowing better ergonomics, are disclosed.

In practice, these solutions do not provide added value to the user from a health point of view. Worse, since the hinges are free, they give rise to rotations during cutting, which complicates the user's work, and maximizes the risk of cuts.

There is a need for scissors with improved ergonomics, which can reduce the risk of MSDs and improve the user's grip, while reducing the risk of cuts.

The invention is intended to solve one or more of the disadvantages identified in the prior art.

The invention thus relates to scissors 1, comprising:
first and second blades 21, 22 pivotally mounted relative to each other around an axis of rotation 91;
an eyelet 3 attached to the first blade 21, the axis 91 being positioned between the eyelet 3 and the first blade 21;
characterized in that:
the eyelet 3 defines a closed contour 32 encircling a passage section 34, the eyelet 3 comprising a protruding element 331, 333 projecting inwards from the passage section 34 relative to the closed contour, according to an orthogonal projection on a cutting plane 92 perpendicular to the axis of rotation 91.

The scissors 1 according to the invention provide additional comfort and help prevent injuries and muscle fatigue. One of the most important advantages of using the scissors 1 according to the invention, especially for hairdressers, is the reduction of muscle fatigue. The scissors 1 according to the invention allow a more balanced distribution of pressure on the fingers, which reduces the strain on the muscles of the hand, wrist and forearm.

Another benefit is improved accuracy and control. The scissors 1 according to the invention provide a more comfortable and stable grip, which allows the user, and in particular the hairdresser, to better control his movements, improve his precision and reduce the risk of tremors.

The use of scissors 1 according to the invention can also help prevent musculoskeletal disorders such as tendonitis, epicondylitis, or joint pain. By reducing the strain on the muscles, tendons, and nerves of the fingers, hands, and forearms, the scissors 1 according to the invention can help prevent these health problems.

In addition, the scissors 1 according to the invention provide increased comfort, especially for hairdressers who spend long hours working with scissors.

By reducing muscle tension and the risk of musculoskeletal disorders, the scissors 1 according to the invention can contribute to their general well-being. In sum, the use of scissors 1 according to the invention can help improve the performance and comfort of users, and in particular hairdressers, while reducing the risk of injury and muscle fatigue.

It should be noted that in the context of an elevation cut, the scissors according to the invention will be particularly advantageous. Indeed, during such a cut, the scissors are in the right hand (in a right-handed person) and a comb is in the left hand. When cutting, the right hand holding the scissors is in a position parallel to the ground, and from 5 cm to 30 cm above the head. In this cutting position, the scissors according to the invention make it possible not to block the thumb, and thus to put less strain on the right wrist.

In one embodiment, said scissors 1 are made of a rigid material, preferably a metal or an alloy of metals, preferably chosen from the group consisting of steel, stainless steel and titanium.

In one embodiment, scissors 1 comprise a rigid material, preferably a metal or an alloy of metals, preferably chosen from the group consisting of steel, stainless steel and titanium.

In one embodiment, eyelet 3 is made of a rigid material, preferably a metal or alloy of metals, preferably chosen from the group consisting of steel, stainless steel and titanium.

In one embodiment, eyelet 3 comprises a rigid material, preferably a metal or alloy of metals, preferably chosen from the group consisting of steel, stainless steel and titanium.

In one embodiment, said scissors 1 are made of a single material. In some cases, this is advantageous, as it allows for less wear and tear.

In one embodiment, said scissors 1 are made up of several different materials. In some cases, this is advantageous, as it allows for easier manufacturing.

For example, the material of the thumb eyelet 3 may be different from that of the 21 and 22 blades.

This is especially beneficial when the thumb eyelet is particularly difficult to produce. It may be appropriate to produce the thumb eyelet in a more ductile material than that of the blades.

In a mode of realization, said scissors are scissors for the practice of hairdressing. This method of realization is preferred, because it is in the field of hairdressing that ergonomics is particularly important, due to the recurrence of certain movements.

In one embodiment, eyelet 3 is attached to lever 51. This means that eyelet 3 cannot be set in motion independently of lever 51. In particular, eyelet 3 is not mounted on a hinge or any other means that allows the eyelet to be moved relative to lever 51. This makes the scissors more ergonomic.

In one embodiment, said scissors 1 comprise a single hinge at the level of the axis of rotation 91.

In one embodiment, said scissors 1 do not include a hinge other than that present at the level of the axis of rotation 91.

In one embodiment, said scissors 1 do not include a hinge at the level of the eyelets. In a construction method, said scissors 1 do not include a hinge at the level of the two eyelets. This method of realization is preferred, as it is beneficial for hairdressers who spend long hours cutting hair. Without a hinge at the eyelets, the tension is evenly distributed over the fingers, reducing fatigue and strain on the joints. It can also help prevent injuries from prolonged use of scissors. In addition, scissors without a hinge at the eyelets can provide greater freedom of movement and control of the cut, allowing hairdressers to work more efficiently.

In one embodiment, the scissors 1 are each made up of a continuity of material. In one embodiment, scissors 1 are each made up of a hingeless continuity of material.

In one embodiment, the length of the scissors is between about 10 cm and about 20 cm, preferably between about 12.5 cm and about 17.5 cm. Preferably, the length of the scissors is about 15 cm.

In one embodiment, the length of the end of the blades at the axis of rotation 91 is between about 5 cm and about 10 cm, preferably between about 7.5 cm and about 12.5 cm.

In one embodiment, the length from the end of the eyelets to the axis of rotation 91 is between about 5 cm and about 10 cm, preferably between about 6 cm and about 8 cm.

In practice, levers 51 and 52 connect each of the two eyelets (including eyelet 3) to blades 21 and 22.

In one embodiment, lever 51 is rectilinear. In one embodiment, lever 52 is straight. In one embodiment, levers 51 and 52 are rectilinear.

Straight levers offer several advantages. First of all, their ergonomic design allows for a comfortable grip and a reduction in muscle fatigue during long cutting sessions. The straight levers also provide better stability and control, allowing for a more precise and cleaner cut. In addition, the scissors 1 according to the invention with straight levers are often lighter than models with curved levers, which allows for more prolonged use without pain or tension in the wrists and fingers.

In one embodiment, said eyelet 3 is a thumb eyelet. This means that it is the one meant to be preempted by the user's thumb.

In one embodiment, the eyelet 3 and the first blade 21 are in one piece.

In one embodiment, said scissors 1 are straight scissors.

In one embodiment, said scissors 1 are off-axis scissors.

In a mode of realization, the said scissors 1 are sculptor scissors.

In one embodiment, said scissors 1 are micro-serrated scissors.

In one embodiment, said scissors 1 are right-handed scissors. This mode of realization is preferred, as most users are right-handed.

In one embodiment, the said scissors 1 are left-handed scissors.

The adaptation of the scissors to right- and left-handed people is important, for obvious ergonomic reasons. In all cases, the thumb is intended to be put in contact with the eyelet 3 of the first blade 21.

When handling scissors 1, the user's thumb comes into contact with eyelet 3, and the protruding element 331, 333 ensures that the thumb does not penetrate too deeply into eyelet 3. Thus, problematic wrist movements can be transferred to the thumb, thus allowing the user to avoid MSDs and their consequences.

In summary, the closed contour allows the user to offer a real point of support for the thumb, allowing him to transfer complex and traumatic movements, in particular from the wrist, directly to the fingers, and in particular to the thumb.

In one embodiment, scissors 1 are characterized in that said element is selected from the group consisting of a lug 331 having a free end 332 or a strip 333 connecting two locations of the closed contour 32.

In one embodiment, said element is a strip 333 connecting two locations of the closed contour.

In one embodiment, said element is a lug 331 having a free end. This method of realization is preferred, because it allows the thumb to be supported, while saving material.

In one embodiment, said free end is rectangular in cross-section.

In one embodiment, the said free end is pointed in shape.

In one embodiment, scissors 1 are characterized in that said element 331 protrudes into the passage section 34 over a length of at least about 5 mm.

In one embodiment, said element 331 protrudes into passage section 34 over a length of at least about 10 millimeters.

In one embodiment, said element 331 protrudes into the passage section over a length of between about 5 millimeters and about 30 millimeters.

In one embodiment, said element 331 protrudes into the passage section over a length of between about 10 millimeters and about 25 millimeters.

In one embodiment, said element 331 protrudes into the passage section over a length of about 15 millimeters.

In one embodiment, scissors 1 are characterized in that said element is a protruding lug 331 with a free end 332 of pointed shape.

In one embodiment, scissors 1 are characterized in that said closed contour 32 comprises a part 321 included in said cutting plane 92 and a part offset 322 in relation to said cutting plane 92 so that closed contour 32 delimits a cutout 323 in said cutting plane 92.

This method of implementation is particularly preferred. Indeed, the cutout 323 created allows the thumb to be relatively free of its movements and in particular concerning the orientation of the scissors induced by the thumb. The combination of said protruding element 331, 333 projecting inwards from the passage section 34 in relation to the closed contour on the one hand, and the cutout 323 on the other hand, allows the thumb to have maximum influence on the position of the scissors, thus transferring maximum movement from the wrist and other joints to the user's thumb.

In one embodiment, the said offset part extends at least 1 cm in relation to the cutting plane 92.

In one embodiment, the said offset part extends at least 2 cm in relation to the cutting plane 92.

In one embodiment, said offset part is offset at an angle A between about 90° and about 170°.

In one embodiment, said offset part is offset at an angle A between about 100° and about 160°.

In one embodiment, said offset part is offset at an angle A between about 110° and about 150°.

In one embodiment, said offset part is offset at an angle A between about 120° and about 150°.

In one embodiment, said offset part is offset at an angle A between about 125° and about 145°.

In one embodiment, said offset part is offset at an angle A between about 135° and about 140°.

In one embodiment, said offset part is offset at an angle A of about 138°. The closer the angle A is to 138°, the more the ergonomics of the scissors 1 are increased.

In one embodiment, scissors 1 are characterized in that said cutout 323 is positioned on an external lateral edge of the closed contour 32.

This method of implementation is particularly preferred. Indeed, it allows the thumb to maintain both a good ability to press the lever 51, while providing it with the possibility of a large number of positions that correspond to the different orientations of the scissors during the haircut.

In one embodiment, scissors 1 are characterized in that the orthogonal projection of said cutout 323 on the cutting plane 92 covers at least the angular sector [40°, 140°] around the point O with respect to the vector OP, with the point O defined as the geometric center of the orthogonal projection of the closed contour 32 on the cutting plane 92, with the point P defined as the intersection between the cutting plane 92 and the axis of rotation 91.

In one embodiment, the scissors 1 are characterized in that the orthogonal projection of said cutout 323 on the cutting plane 92 covers at least the angular sector [50°, 130°] around the point O with respect to the vector OP, with the point O defined as the geometric center of the orthogonal projection of the closed contour 32 on the cutting plane 92, with the point P defined as the intersection between the cutting plane 92 and the axis of rotation 91.

In one embodiment, the scissors 1 are characterized in that the orthogonal projection of said cutout 323 on the cutting plane 92 covers at least the angular sector [60°, 120°] around the point O with respect to the vector OP, with the point O defined as the geometric center of the orthogonal projection of the closed contour 32 on the cutting plane 92, with the point P defined as the intersection between the cutting plane 92 and the axis of rotation 91.

In one embodiment, scissors 1 are characterized in that the orthogonal projection of said cutout 323 on the cutting plane 92 covers at least the angular sector [70°, 110°] around the point O with respect to the vector OP, with the point O defined as the geometric center of the orthogonal projection of the closed contour 32 on the cutting plane 92, with the point P defined as the intersection between the cutting plane 92 and the axis of rotation 91.

In one embodiment, the scissors 1 are characterized in that the orthogonal projection of said cutout 323 on the cutting plane 92 covers at least the angular sector [80°, 100°] around the point O with respect to the vector OP, with the point O defined as the geometric center of the orthogonal projection of the closed contour 32 on the cutting plane 92, with the point P defined as the intersection between the cutting plane 92 and the axis of rotation 91.

In one embodiment, scissors 1 are characterized in that the orthogonal projection of said cutout 323 on the cutting plane 92 covers at least the angular sector [85°, 95°] around the point O with respect to the vector OP, with the point O defined as the geometric center of the orthogonal projection of the closed contour 32 on the cutting plane 92, with the point P defined as the intersection between the cutting plane 92 and the axis of rotation 91.

In one embodiment, the scissors 1 also comprise a support lug 35 projecting inwards from the passage section 34 in relation to the closed contour 32.

The presence of a support lug 35 is particularly desirable; It allows an easier opening of the scissors with the upper surface of the thumb.

In a particularly preferred embodiment, a cutout 323 is present, and the scissors also include a support lug 35 projecting inwards from the passage section 34 in relation to the closed contour 32 and positioned adjacent to said cutout 323. In the latter case, there is a real synergy between the cutout 323 allowing freedom of the thumb and the support lug 35 which allows the scissors to maintain an ease of opening between two approaches of levers 51 and 52, i.e. between two cutting gestures.

In a particularly preferred embodiment, the support lug 35 is also protruding from the cutting plane 92. FIG. 12 illustrates this particular embodiment, which is preferred because it allows maximum maneuverability of the scissors.

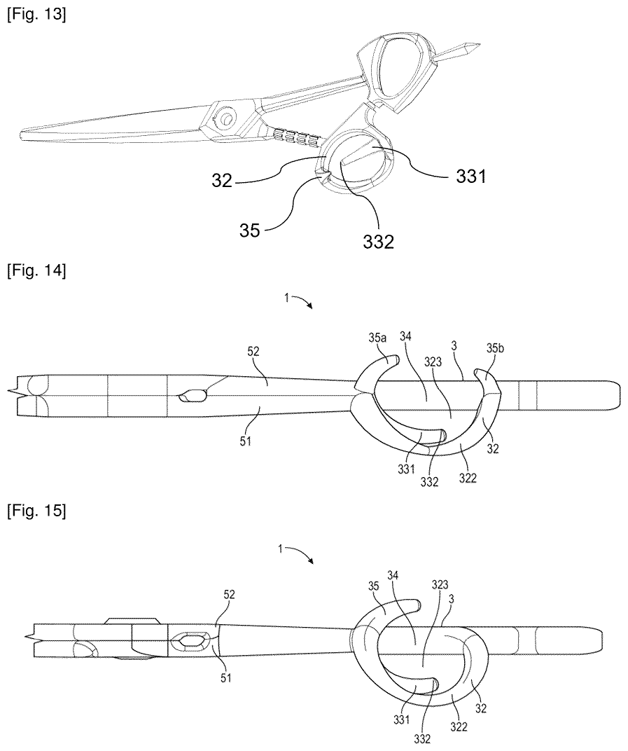

In a particularly preferred embodiment, the support lug 35 and element 331 (e.g., a lug with a free end 332) originate in opposite portions of the closed contour 32. FIG. 13 illustrates this particular embodiment, which is preferred, because it allows the thumb to be channeled between the said support lug 35 and the said element 331. The thumb is well centered between these two elements, which is advantageous.

In one embodiment, said support lug 35 is at least about 1 mm long, preferably at least about 2 mm, preferably at least about 3 mm, preferably at least about 4 mm.

In one embodiment, said support lug 35 is about 1 mm long, preferably about 2 mm, preferably about 3 mm, preferably about 4 mm.

In one embodiment, scissors 1 include two support lugs 35a and 35b.

In one embodiment, scissors 1 comprise two support lugs 35a and 35b, each projecting inwards from the passage section 34 in relation to the closed contour 32. In a preferred embodiment, these two lugs are located on either side of the closed contour 32.

The presence of several support lugs 35 is particularly desirable; It allows an easier opening of the scissors with the upper surface of the thumb, with a distribution of loads to reduce friction at the skin of the thumb.

In one embodiment, at least one support lug 35 and element 331 originate within the same portion of the closed contour 32.

In one embodiment, scissors 1 are characterized in that the offset part 322 and said protruding element 331 are offset on the same side in relation to said cutting plane 92.

In one embodiment, scissors 1 are characterized in that the offset part 322 and the said protruding element 331 are located on the same side in relation to said cutting plane 92.

In one embodiment, scissors 1 are characterized in that said eyelet 3 is mounted removable in relation to the first blade 21 by means of a fixing interface 6, the fixing interface 6 allowing the eyelet 3 to be attached in several angular positions around an axis 93 perpendicular to the axis of rotation 91 of the first and second blades 21, 22.

In one embodiment, the said angular positions are 12 in number, and are therefore distant from each other by an angle of 30°.

In one embodiment, the said angular positions are 12 in number, and are therefore distant from each other by an angle of 30°, because 30 times 12 is equal to 360° (a complete rotation).

In one embodiment, scissors 1 are characterized in that the said element is offset in relation to the first blade 21 in a direction corresponding to the axis of rotation.

The invention also relates to the use of scissors 1 according to the invention to reduce the risk of MSD occurrence.

The invention also relates to scissors 1 according to the invention intended to be used to reduce the risk of MSD occurrence.

The invention also covers the variants shown in this description. The skilled person will understand that each of the features of these variants can be combined, but does not constitute an intermediate generalization.

Other features and advantages of the invention are clear from the description, by way of indication and by no means limiting, with reference to the attached drawings, in which:

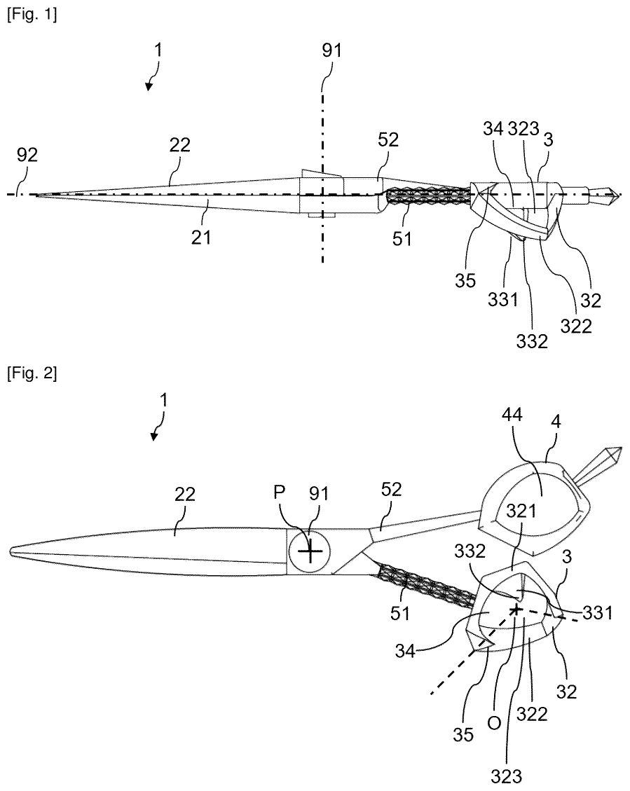

FIG. 1 illustrates scissors 1 for the practice of hairdressing according to the invention, comprising first and second blades 21, 22 pivoting mounts in relation to each other around the axis 91 of rotation. The cutting plane 92 is also shown, as well as levers 51 and 52. These levers 51, 52 are rectilinear. The eyelet 3 intended to come into contact with the thumb and integral to the first blade 21 is represented. More precisely, eyelet 3 defines a closed contour 32 encircling a passage section 34 and comprises an element 331 being a lug having a free end 332 projecting inwards from the passage section 34 in relation to the closed contour, according to an orthogonal projection on the cutting plane 92 perpendicular to the axis of rotation 91. Part 322 of eyelet 3 is offset from the cutting plane 92. A support lug 35 projecting inward from the passage section 34 from closed contour 32 is shown, and a cutout 323 is positioned on an external lateral edge of closed contour 32 and positioned adjacent to said cutout 323. The protruding support lug 35 allows the thumb to spread the levers 51, 52 easily, thus providing a real fulcrum.

FIG. 2 shows the same scissors as those shown in FIG. 1, seen from a different angle. The description of FIG. 1 corresponding to the numbers present in FIG. 1 and FIG. 2 is therefore applicable to this FIG. 2. The eyelet 4 corresponding to lever 52, as well as its passage section 44, is shown. In addition, the orthogonal projection of said cutout 323 on the cutting plane 92 (not shown) covers a certain angular sector around the point O with respect to the vector OP, with the point O defined as the geometric center of the orthogonal projection of the closed contour 32 on the cutting plane 92, with the point P defined as the intersection between the cutting plane 92 and the axis of rotation 91.

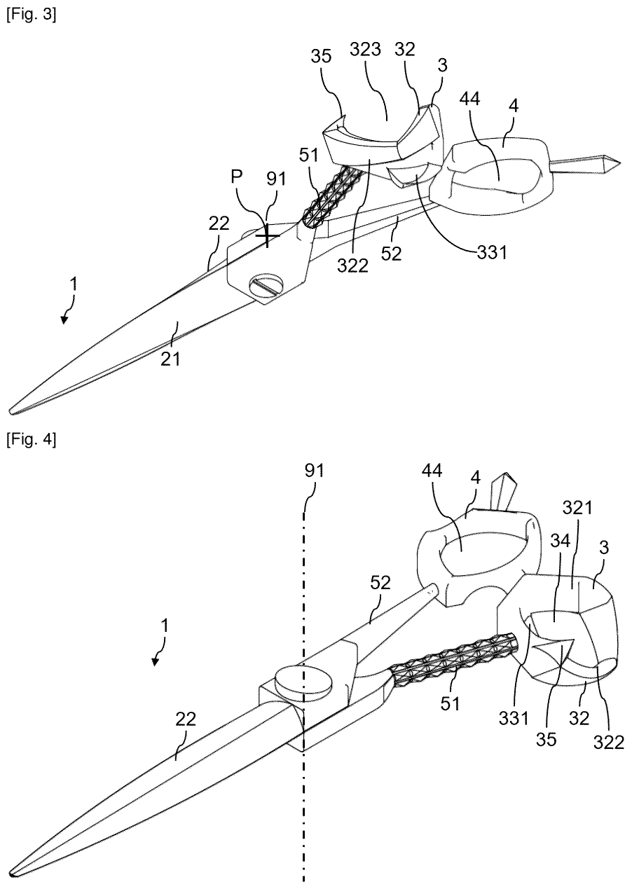

FIG. 3 shows the same scissors as those shown in FIGS. 1 and 2, seen from a different angle. The description of FIGS. 1 and 2 corresponding to the numbers present in FIGS. 1 and/or 2 and FIG. 3 is therefore applicable to this FIG. 3.

FIG. 4 shows the same scissors as those shown in FIGS. 1 and 2, seen from a different angle. The description of FIGS. 1 and 2 corresponding to the numbers present in FIGS. 1 and/or 2 and FIG. 4 is therefore applicable to this FIG. 4. In FIG. 4, axis 91 is vertical.

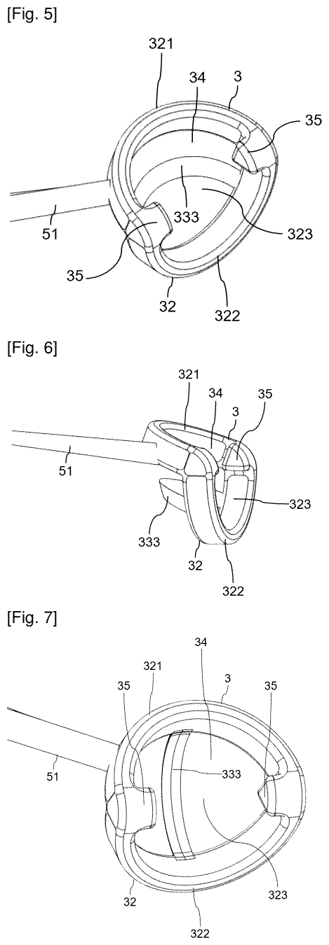

FIG. 5 is a detail view of an eyelet 3 corresponding to a lever 51. The passage section 34 in relation to the closed contour 32 is shown. Eyelet 3 has both a support lug 35 projecting inwards from the passage section 34, and a strip 333 connecting two locations in the closed contour 32. The closed contour 32 has a part 321 included in the cutting plane (not shown), and a part offset 322 with respect to the said cutting plane, so that the closed contour delimits a cutout 323 in the said cutting plane.

FIG. 6 shows the same eyelet 3 as shown in FIG. 5, seen from a different angle. The description of FIG. 5 corresponding to the numbers present in FIG. 5 is therefore applicable to this FIG. 6.

FIG. 7 is a detail view of an eyelet 3 corresponding to a lever 51. The passage section 34 in relation to the closed contour 32 is shown. Eyelet 3 has both a support lug 35 projecting inwards from the passage section 34, and a strip 333 connecting two locations in the closed contour 32. The closed contour 32 has a part 321 included in the cutting plane (not shown), and a part offset 322 with respect to the said cutting plane, so that the closed contour delimits a cutout 323 in the said cutting plane.

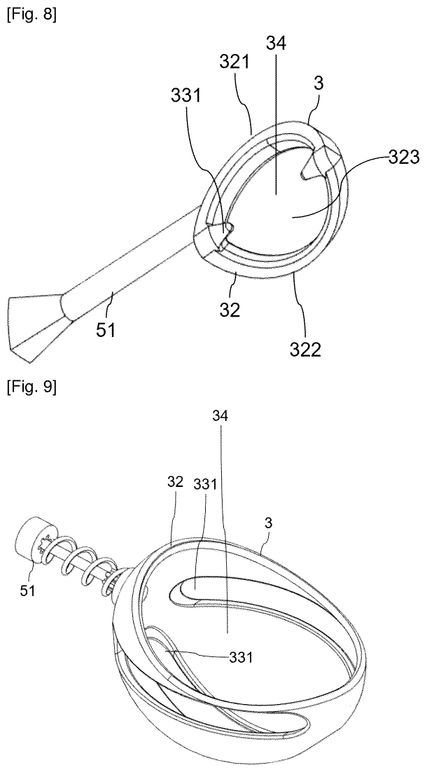

FIG. 8 is a detail view of an eyelet 3 corresponding to a lever 51. The passage section 34 in relation to the closed contour 32 is shown. Eyelet 3 has an element in the form of a lug 331 projecting inwards from the passage section 34. The closed contour 32 has a part 321 included in the cutting plane (not shown), and a part offset 322 with respect to the said cutting plane, so that the closed contour delimits a cutout 323 in the said cutting plane.

FIG. 9 is a detail view of an eyelet 3 corresponding to a lever 51. The passage section 34 in relation to the closed contour 32 is shown. Eyelet 3 has an element in the form of a strip 331 of variable width projecting inwards from the passage section 34.

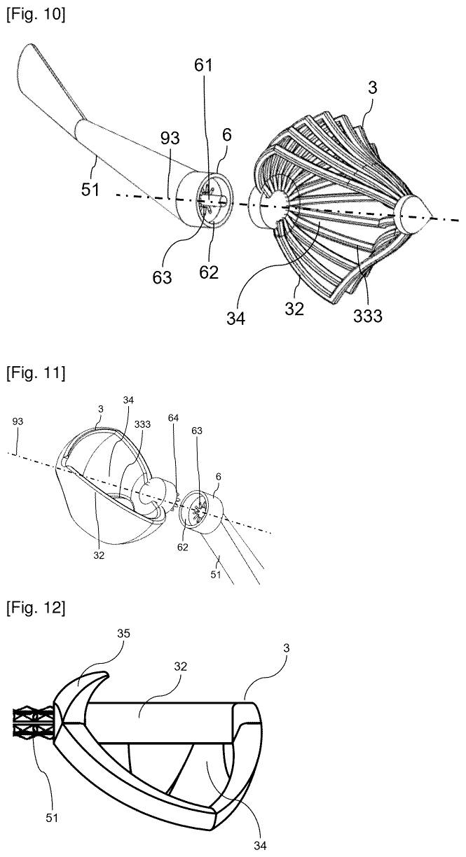

FIG. 10 is an exploded detail view of an eyelet 3 corresponding to a lever 51. The passage section 34 in relation to the closed contour 32 is shown. Eyelet 3 has an element in the form of strips 333. Eyelet 3 and lever 51 are connected by a fixing interface 6 consisting of a shaft 61, a bore 62, and indexing holes 63 allowing eyelet 3 to be positioned at a plurality of angles relative to the adjustment axis 93. The attachment interface allows the scissor user to position the eyelet 3 at the desired angle before setting the scissors in motion. During a haircut, the user will be able to use one or more position(s) according to his needs and desires.

FIG. 11 is an exploded detail view of an eyelet 3 corresponding to a lever 51. The passage section 34 in relation to the closed contour 32 is shown. Eyelet 3 has an element in the form of a strip 333. Eyelet 3 and lever 51 are connected by a fixing interface 6 consisting of indexing lugs 64, a bore 62, and indexing holes 63 allowing eyelet 3 to be positioned at a plurality of angles relative to the adjustment axis 93. The attachment interface allows the scissor user to position the eyelet 3 at the desired angle before setting the scissors in motion. During a haircut, the user will be able to use one or more position(s) according to his needs and desires.

FIG. 12 is a detail view of an eyelet 3 corresponding to a lever 51. Eyelet 3 differs from the one shown in FIG. 1 in that the support lug 35, which, as in FIG. 1, protrudes inwards from the passage section 34 in relation to the closed contour 32, is also protruding from the cutting plane 92. This method of execution is preferred, as it allows perfect handling of the scissors.

FIG. 13 illustrates a preferred embodiment in which the support lug 35 and the element 331 being a lug with a free end 332 originate in opposite portions of said closed contour 32.

FIG. 14 illustrates a preferred embodiment in which eyelet 3 has several support lugs 35a and 35b. In addition, the protruding lug 331 is located in front of the support lug 35a.

FIG. 15 illustrates a preferred embodiment in which the protruding lug 331 is located in front of the support lug 35.

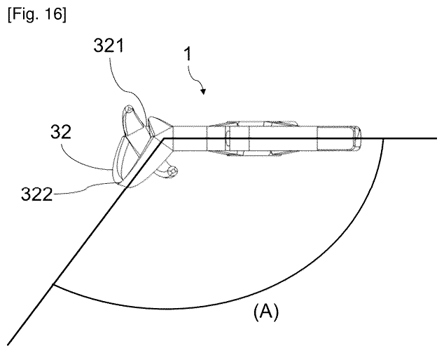

FIG. 16 shows scissors 1 according to the invention seen from behind, having a closed contour 32 comprising a part 321 included in the cutting plane and a part offset 322 from the said cutting plane. The offset part is offset at an angle A of 138°.

1. Scissors (1), comprising:
first and second blades (21, 22) pivotally mounted relative to each other around an axis of rotation (91);
an eyelet (3) attached to the first blade (21), the axis (91) being positioned between the eyelet (3) and the first blade (21); characterized in that:
the eyelet (3) defines a closed contour (32) encircling a passage section (34), the eyelet (3) comprising an protruding element (331, 333) projecting inwards from the passage section (34) relative to the closed contour, according to an orthogonal projection on a cutting plane (92) perpendicular to the axis of rotation (91).

2. Scissors (1) according to claim 1, wherein said element is selected from the group consisting of a lug (331) having a free end (332) or a strip (333) connecting two locations of the closed contour (32).

3. Scissors (1) according to claim 1, wherein said element (331) protrudes into the passage section (34) for a length of at least 5 millimeters.

4. Scissors (1) according to claim 2, wherein said element is a protruding lug (331) with a free end (332) of pointed shape.

5. Scissors (1) according to claim 1, wherein said closed contour (32) comprises a part (321) included in said cutting plane (92) and an offset part (322) from said cutting plane (92) such that the closed contour (32) delimits a cutout (323) in said cutting plane (92).

6. Scissors (1) according to claim 5, wherein said offset part (322) is offset at an angle (A) between 90° and 170°, preferably between 100° and 160°, preferably between 110° and 150°, preferably between 120° and 150°, preferably between 250° and 145°, preferably between 135° and 140°.

7. Scissors (1) according to claim 5, wherein said cutout (323) is positioned on an external lateral edge of the closed contour (32).

8. Scissors (1) according to claim 7, wherein the orthogonal projection of said cutout (323) on the cutting plane (92) covers at least the angular sector [40°, 140°], preferably at least the angular sector [50°, 130°], preferably at least the angular sector [60°, 120°], preferably at least the angular sector [70°, 110°], preferably at least the angular sector [80°], 100°], preferably at least the angular sector [85°, 95°] around the point O with respect to the vector OP, with the point O defined as the geometric center of the orthogonal projection of the closed contour (32) on the cutting plane (92), with the point P defined as the intersection between the cutting plane (92) and the axis of rotation (91).

9. Scissors (1) according to claim 5, further comprising a support lug (35) projecting inwards from the passage section (34) in relation to the closed contour (32).

10. Scissors (1) according to claim 9, wherein said support lug (35) is at least 1 mm long, preferably at least 2 mm, preferably at least 3 mm, preferably at least 4 mm.

11. Scissors (1) according to claim 5, further comprising two support lugs (35a) and (35b) projecting inwards from the passage section (34) in relation to the closed contour (32).

12. Scissors (1) according to claim 5, wherein the offset part (322) and said protruding element (331) are offset on the same side with respect to said cutting plane (92).

13. Scissors (1) according to claim 1, wherein said eyelet (3) is mounted removable with respect to the first blade (21) by means of a fixing interface (6), the fixing interface (6) allowing the eyelet (3) to be secured said eyelet (3) to be attached in several angular positions around an axis (93) perpendicular to the axis of rotation (91) of the first and second blades (21, 22).

14. Scissors (1) according to claim 1, wherein said eyelet (3) is attached to said lever (51).

15. Scissors (1) according to claim 1, wherein said scissors (1) do not include a hinge other than that present at the level of the axis of rotation 91.

16. Scissors (1) according to claim 1, wherein said scissors (1) do not include a hinge at the level of the two eyelets.
